(19) United States
(12) Patent Application Publication
(10) Pub. No.: US 2015/0108827 A1
(43) Pub. Date: Apr. 23, 2015

(54) Size Adapter for Axle Spindles on Small Boat Dollies

(71) Applicants: James Woodrow Beauchamp, Atlanta, GA (US); Thomas Lee Beauchamp, Atlanta, GA (US); Robert Frazier Beauchamp, Atlanta, GA (US)

(72) Inventors: James Woodrow Beauchamp, Atlanta, GA (US); Thomas Lee Beauchamp, Atlanta, GA (US); Robert Frazier Beauchamp, Atlanta, GA (US)

(21) Appl. No.: 14/058,232

(22) Filed: Oct. 19, 2013

(51) Int. Cl. B60B 35/02; B60B 35/00; B60B 35/04

(52) U.S. Cl. CPC B60B 35/025; B60B 35/04; B60B 35/004; B60B 2900/351
USPC 301/132; 16/2.1

(57) ABSTRACT

One embodiment of a spindle size adapter for dolly axles to provide adaptability to and use of replacement wheels with various axle hub sizes. The spindle size adapter has a proximal end which mates closely into the existing axle frame to stabilize the new axle in the vertical, fore and aft and horizontal position and a distal end that forms the new axle spindle. The size of the adapter spindle is designed to match the most common available hub sizes used in aftermarket dolly wheels but is adapted to different hub sizes by sheathing the spindle with adapter sleeves. The spindle size adapter can be used with or without the original equipment manufacturer (OEM) existing spindle brackets because the manufacture's brackets are not needed to stabilize the spindle adapter. In another embodiment the shape of the middle part of the dolly axle size adapter is modified to be compatible with the form of the OEM axle brackets. Other embodiments allow a variety of spindle sizes and are described and shown.

### CROSS-REFERENCE TPO RELATED APPLICATIONS

This application claims the benefit of provisional patent application Ser. No. 61/729,398, filed Nov. 22, 2012 by the present inventors.

### FEDERALLY SPONSORED RESEARCH

None

### SEQUENCE LISTING

None

### BACKGROUND

This relates to boat dolly wheels and axle spindle sizes. Boat dollies are light weight structures used to portage small boats to and from water, hand launch small boats into water from beaches, ramps or other shores and store boats in boat yards. A number of dolly designs are currently available in the marketplace consisting of an axle, spindle, wheels, light frame, and handle. Most dollies for small sailboats use similar designs modified to fit specific one-design sailboats. Over a hundred thousand of these boats have been sold in the United States.

Most dollies and axles are framed with square (or sometimes round) aluminum tubing. Wheels are usually attached to the axle by means of a short round metal tube called a spindle that extends axially from the axle frame. Various brackets and fasteners are used to attach the spindle to the axle frame (Examples shown in FIGS. 1A through 1C). Normally, these brackets and fasteners securely hold the axle spindle in a stable position either by means of internal ferrules or spacers 36 as shown in the cutaway view FIG. 1B or matching grooves 37 in the bracket shown in FIG. 1C. The close mating of these entities with the spindle limit 3 dimensional movement of the spindle. The spindle inserts through a hub of the wheel and the wheel is secured on the spindle by means of a cotter pin or similar attaching device.

Since small boat dollies are subjected to low load forces (less than 500 pounds), the wheels and tires are usually of low load specification. Typically, the spindle is a hollow tube and therefore cannot be less than a minimum size to accommodate fasteners and still have sufficient residual strength to support the small boat. On commercially available small sailboat dollies, the spindle is not interchangeable with spindles that have smaller sized outside diameters, and therefore cannot accept wheels with smaller wheel hubs. No size adapter systems are commercially available.

The wheels and tires of small sailboat dollies have a limited life span due to deterioration of the rubber tire and/or the plastic wheel rim produced by dolly use, weather, and UV radiation of the sun and are considered replaceable items. For replacement, wheels and tires are typically sold as a unit. Widely available aftermarket wheel and tire combinations meeting tire load specifications of original equipment have hubs requiring spindles with a diameter size smaller than the original equipment. Since the original equipment manufacturers (OEM) wheel hub size on the small sailboat dollies is normally limited to the relatively large manufactured spindle size, the user of the dolly is primarily limited to the choice of replacement wheels supplied by the manufacturer, and has a very limited choice of aftermarket wheel and tire combination.

Many of the aftermarket wheels with small hubs have a variety of desirable characteristics useful for portage of boats over different terrains and ramp conditions. These include tires designed for sandy beaches, tires that will not go flat and tires of different widths and/or diameters to accommodate rough terrain. These aftermarket wheels cannot be used with the original dolly spindle because the original spindle cannot be modified or replaced to fit the aftermarket wheels with smaller diameters. Also wheels with these characteristics are not readably available with hub sizes matching the original equipment at competitive costs. In conclusion, none of the current spindle attachment methods to the axle frame allow the use of different hub sizes available in aftermarket replacement dolly wheels.

### SUMMARY

Our spindle size adapter improves current designs by allowing the user the option of substituting a variety of different dolly spindle sizes. The different spindle size options provide the opportunity to use a variety of aftermarket wheels and tires accommodating different utilization requirements by the user. In accordance with the first embodiment, a size adapter for a dolly axle spindle comprises two elements, a proximal element that mates with an existing axle frame and serves to stabilize the adapter, and a distal element that provides a spindle having a variety of spindle sizes that allows using wheels with different hub sizes.

### ADVANTAGES

Accordingly several advantages of one or more aspects are as follows: to allow the user to replace wheels for boat dollies with replacement wheels that have different hub sizes than original equipment manufacturer (OEM) supplied wheels. These replacement wheels are relatively inexpensive compared with OEM wheels and are available in a wide variety of styles to meet different terrain conditions. The variety of styles provides the user with the means to optimize the portage of his boat depending on the terrain on which he portages and launches his boat by fitting the needs to the wheel and tire design. Since the adapter provides its own stabilization to the axle frame or tube by the close mating surfaces of the proximal end of the size adapter against the inner sides of the axle frame tubing, the size adapter can be used with or without the OEM existing brackets. The distal end of the adapter (spindle) is rounded to the inside diameter of commonly available wheel hubs. Several embodiments can be used to adjust the outer diameter of the spindle to different sizes to increase the utility and adaptability of the claimed device.

Other advantages of one or more aspects will be apparent from a study of the following description and accompanying drawings.

### DRAWINGS

FIGS. 1A to 1C—Examples of prior art. Perspective views of common spindle brackets and attachment of spindles

FIG. 1A Perspective right-side close-up view axle frame, spindle, and spindle bracket using ferrules to achieve spindle stabilization.

FIG. 1B Perspective right-side cutaway view of spindle and spindle bracket showing details of ferrules to achieve spindle stabilization.

FIG. 1C Perspective partially exploded right-side close-up view of spindle, and spindle bracket showing a groove to achieve spindle stabilization.

FIG. 2A shows a perspective partially exploded right-side view of spindle size adapter showing adapter washers and fasteners of the first embodiment.

FIG. 2B shows a perspective right-side view of the first embodiment of the axle spindle size adapter fitting into a square axle frame and showing adapter washers for bolts to fit manufacturer drilled holes in square axle frame.

FIG. 3 shows a perspective left-side view of the first embodiment of the axle spindle size adapter constructed to fit an existing OEM bracket.

FIG. 4 shows a perspective right-side view of an additional embodiment of the axle spindle size adapter constructed in accordance with the invention.

FIG. 5 shows a perspective right-side view of the first embodiment of the axle spindle size adapter fitted with a hub adapter sleeve.

FIG. 6 shows a perspective right-side view of an additional embodiment of the axle spindle size adapter with center lumen providing alternate means for fitting axle spindle of different sizes.

FIG. 7 shows a perspective right-side view of an additional embodiment of the axle spindle size adapter machined to fit a round axle frame or an existing OEM spindle bracket.

FIG. 7A shows a perspective right-side view of an alternative embodiment of the axle spindle size adapter in FIG. 7 that allows use of either distal or proximal end as axle spindle.

FIG. 8 shows a perspective front-side view of an additional embodiment of a round axle spindle size adapter stabilized in a square axle frame using stabilizer bushing.

### REFERENCE NUMBERS

11, 11A, and 11B Spindle size adapter for dolly

11C and 11D Spindle size adapter modified to match round axle frame or OEM spindle bracket

12 Proximal element of spindle size adapter that fits into square frame of axle tube

12A Proximal element of spindle size adapter that fits into round frame of axle tube or adapted to larger frames or OEM spindle bracket

13 Distal element of spindle size adapter that forms a spindle that fits into wheel hub

13B Proximal extension of proximal element of spindle size adapter that provides different sized distal element of spindle size adapter that forms a spindle that fits into wheel hub when proximal and distal ends are reversed

14 Interconnecting element of spindle size adapter to fit manufacturers preexisting bracket

14A interconnecting element of spindle size adapter that fits into round frame of axle tube or adapted to larger frames or OEM spindle bracket

15 Holes for bolt(s), screws or other fasteners

15A Holes for fasteners in spindle size adapter

17 Hole for cotter pin or other devices to hold wheel on axle

18 Rounded edge to match inner corners of square tube axle frame

19 Sleeve adapter for spindle size adapter manufactured to match other sizes of wheel hubs

20 Adapter washers to adapt bolts to existing OEM oversize holes in square axle frame

21 Fasteners

22 Axle frame

23 Existing OEM bracket for axle spindle

24 Outer retaining washer

25 Cotter pin

26 Existing OEM axle spindle

27 Vertical strut on dolly axle to support boat or retain boat on dolly

28 Wheel hub

29 Lumen of adapter sleeve

30 Axial lumen in proximal element of spindle size adapter

31 Proximal end of distal element of spindle size adapter

32 Nuts to secure fasteners

33 Stabilizer bushing

34 Stabilizer bushing cap

35 Stabilizer bushing ferrule

36 Ferrules or spacers on existing OEM axle spindle bracket

37 Groove to stabilize axle spindle on existing OEM axle spindle bracket

### DETAILED DESCRIPTION

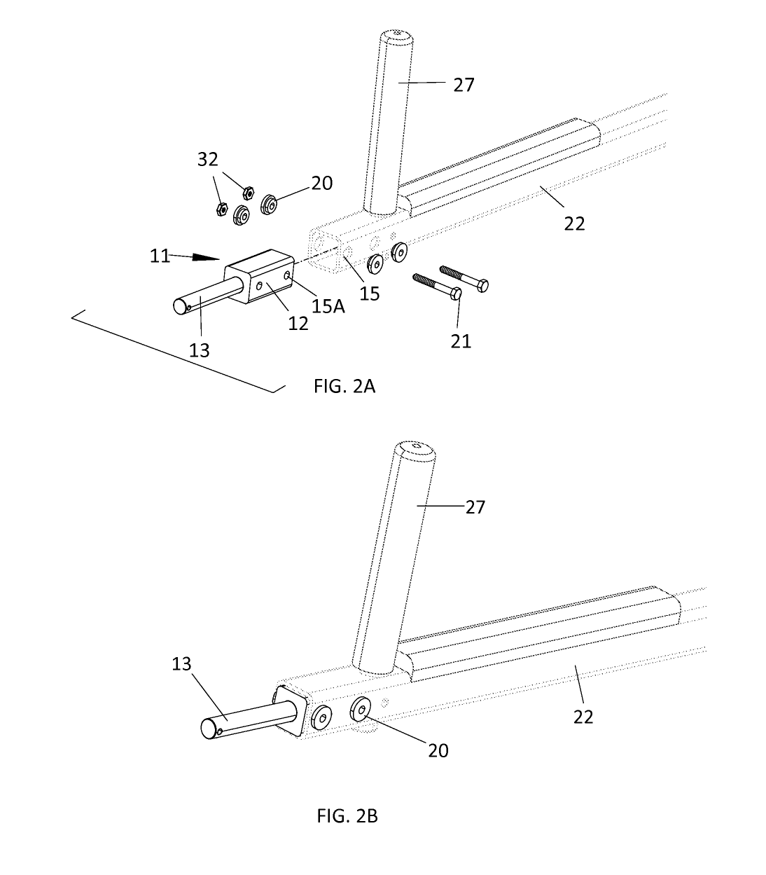

### FIGS. 2A, 2B, 3, AND 5

### First Embodiment

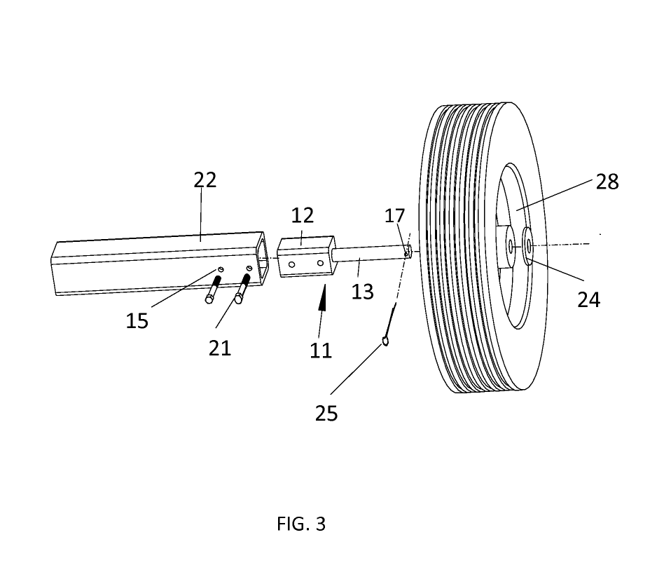

FIGS. 2A, 2B, 3, & 5 show a perspective view of one embodiment of our spindle size adapter 11 that improves an existing manufacturer's axle spindle 26 illustrated in 1A. The composition of spindle size adapter 11 is machined, cast, or extruded aluminum or other metals, molded, machined, or extruded plastics or molded or machined laminated fibrous materials of sufficient strength to support the dolly and boat with all its attachments. Alternatively individual parts or modules of the same materials are securely assembled by attaching devices or welding.

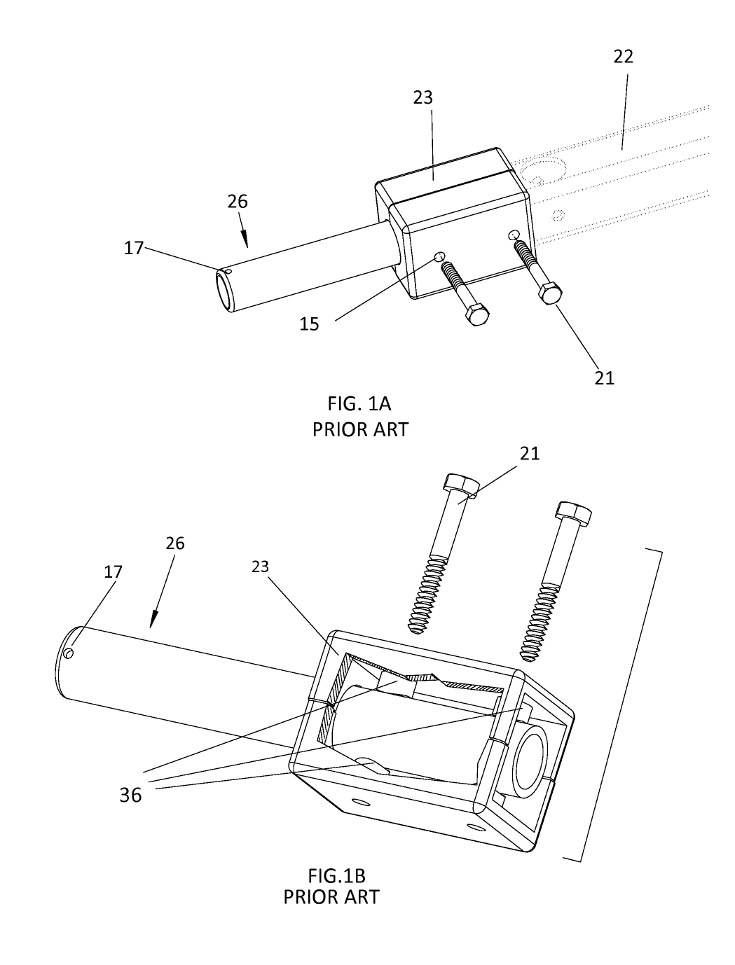

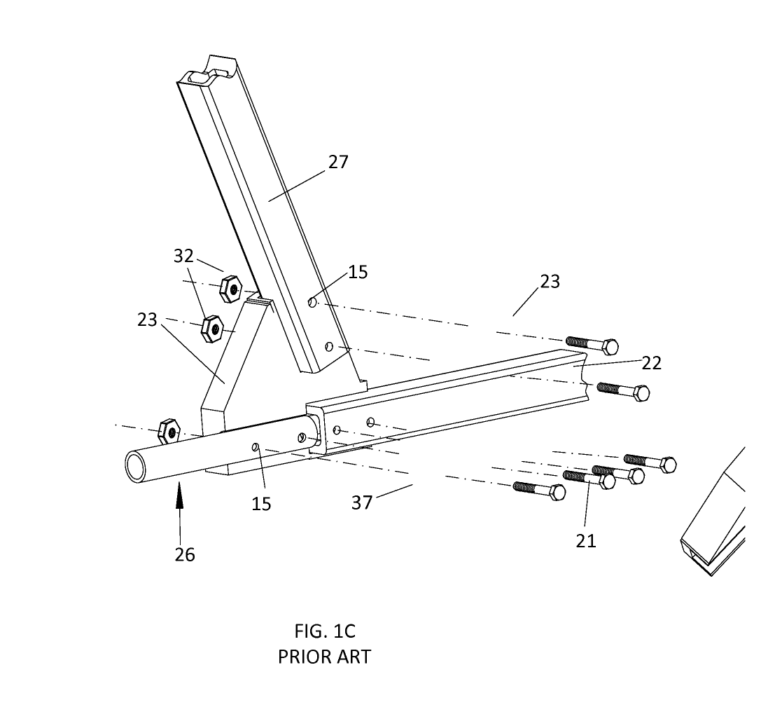

The spindle size adapter 11 shown in FIG. 2A comprises a proximal element 12 and a distal element 13. Element 12 is manufactured to mate closely into the inside of an existing axle frame 22 (either square or round). The longitudinal edges 18 shown in FIG. 5 of proximal element 12 are rounded or shaped as necessary to match the inside channel of existing axle frame 22. Adapter 11 is held in place by means of fastener(s) 21 placed into existing axle frame 22 holes 15 and adapter 11 holes 15A perpendicular to the axis of axle frame 22 and element 12. Proximal element 12 serves to stabilize the spindle adapter 11 in the vertical, fore and aft and horizontal position as shown in FIG. 2B by locking adapter 11 to the axle frame 22. This function is independent of any existing manufacturer's spindle bracket 23 in FIG. 1A.

Element 13 of axle size adapter 11 shown in FIGS. 2A and 3 forms a new axle spindle. Element (or spindle) 13 of adapter 11 is manufactured or machined as a rod or tube to fit the inside diameter of commonly available wheel hubs illustrated in FIG. 3. FIG. 3 shows a hole 17 is placed at the outer or distal end of element 13 to accept a cotter pin 25 or similar devices and secure the wheel hub 28 shown in FIG. 3.

FIG. 5 illustrates one means to vary the size of adapter spindle 13 to fit a variety of wheel hubs 28 shown in FIG. 3 that have different sized inside diameter. Sleeves 19 of different outside diameters are manufactured to contain a round axial lumen 29 that is equal in size to the spindle diameter of element 13 of spindle adapter 11. When adapter spindle 13 is inserted into the lumen 29, sleeve 19 effectively changes adapter spindle 13 size to a new diameter.

### Operation—FIGS. 1A, 2A, 2B, 3, and 5

In operating this embodiment (Fids. 2A, 2B, 3, 5), one uses the axle spindle size adapter 11 to allow replacement of the existing wheel and tire with another wheel and tire having a different hub size. By using a sleeve adapter 19 on the axle spindle size adapter shown in FIG. 5, the user will have a choice of multiple hub sizes. The use consists of the following steps:

1. To install the axle spindle adapter, the fasteners 21 shown in FIG. 1A holding the manufacturer's brackets 23 and the dolly axle spindle 26 are removed freeing the existing axle spindle 26.
2. The proximal end of the spindle size adapter 12 is inserted into the square (or other geometric shape) axle frame tube 22 and the existing bolt holes or screw holes 15A aligned with those of the axle spindle size adapter 15 as shown in FIG. 2A.
3. If the manufacturer's brackets 23 in FIG. 1A are to be reused, these are mated to the axle frame and the fasteners 21 inserted through the holes 15 in the brackets 23, the axle frame 22 and the spindle size adapter 11 holes 15A and tightened.
4. If the manufacturer's brackets 23 in FIG. 1A were not to be reused, appropriately designed adapter washers 20 shown in FIGS. 2A, 2B are used to adapt holes 15, if over sized, existing in the axle frame to fasteners 21. Fasteners 21 are inserted through the holes in the washers 20, the axle frame 22 holes 15 and the axle spindle size adapter 11 holes 15A and tightened.
5.The adapter's axle spindle 13 is inserted into the hub of a new wheel 28 in FIG. 3 and the retaining washer 24 and cotter pin (or other device) 25 is inserted through the hole 17 in the outer end of the spindle adapter 11.
6. Or if needed the outer axle spindle 13 is inserted into a axle adapter sleeve 19 and the process step 5 is repeated.

### FIGS. 1A, 1B, 4, 5, 6, 7 and 8

### Additional Embodiments

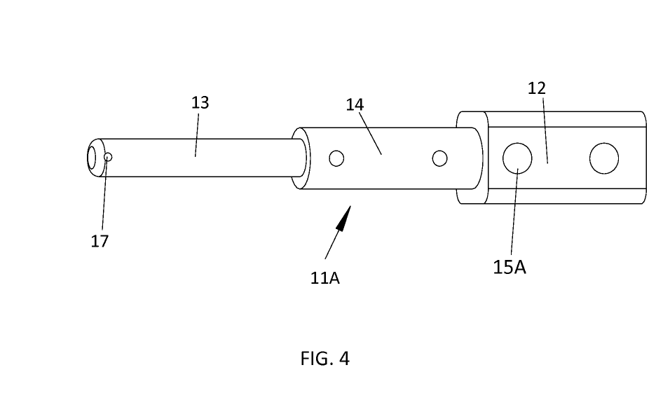

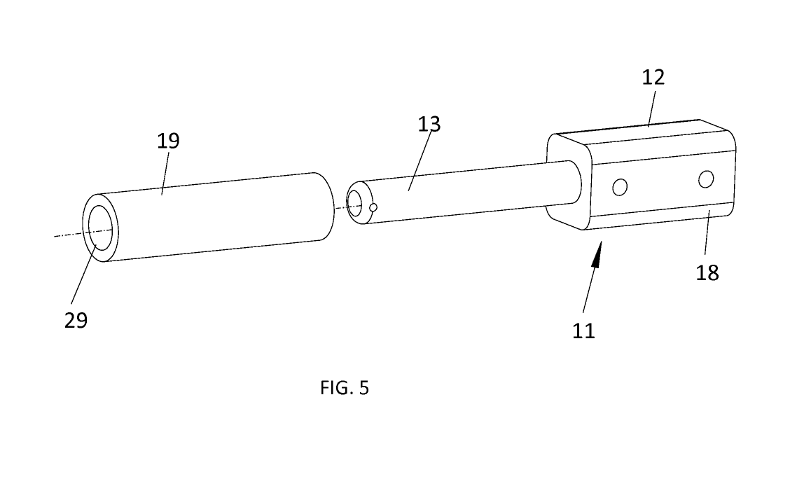

FIG. 4 shows another embodiment of our spindle size adapter 11A that provides an interconnecting element 14 between the proximal element 12 and the distal element 13. Interconnecting element 14 is manufactured to mate with the structural shape of any existing manufacturer's spindle bracket 23 illustrated in FIG. 1B external to the axle frame 22. This embodiment provides the means to use spindle size adapter 11A without interference caused by existing spindle bracket 23 due to geometric configuration of size, shape or length. When necessary, interconnecting element 14 contains hole(s) 15A to match the location of existing manufacturer's fasteners 21 shown in FIG. 1B.

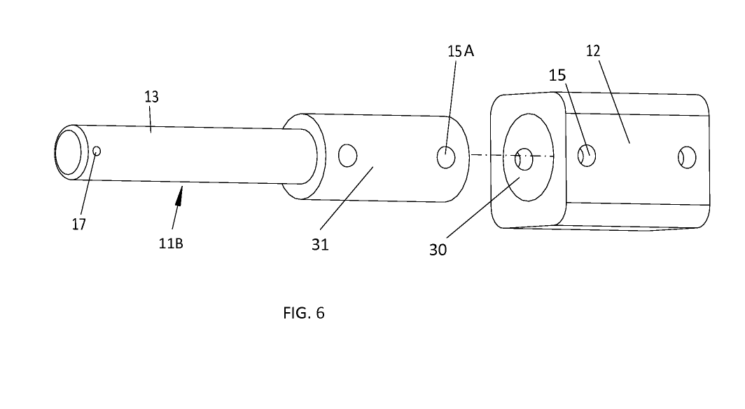

FIG. 6 illustrates another embodiment 11B that provides an optional means to vary the size of adapter's spindle 13. Proximal element 12 is manufactured as that in the first embodiment 11 but contains an axial lumen 30. Distal element 13 is manufactured with a proximal end 31 rounded to equal the size of the lumen 30. Mating of the proximal element 31 of element 11B with element 30 of proximal element 12 stabilizes adapter's spindle 13 in the vertical, horizontal and fore and aft direction. Element 13 of axle adapter 11B will be manufactured to different sizes or use adapter sleeves shown in element 19 of FIG. 5 adding the ability to vary spindle size.

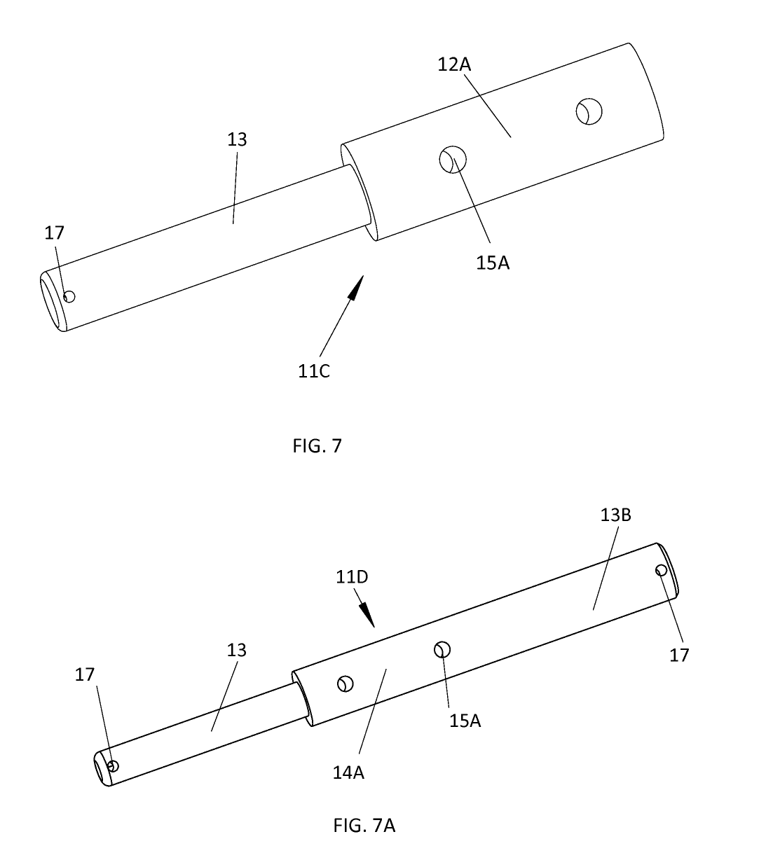

FIG. 7 shows an additional embodiment 11C designed to provide a means to stabilize the axle size adapter 11C when using a round axle frame. To manufacture this embodiment, the proximal element 12A of adapter 11C is rounded to mate with the lumen of a round axle frame and fixed in position with fasteners. Similar to other embodiments, this embodiment offers the option of variable spindle sizes. This embodiment may be substituted for a manufacturer's existing spindle if the diameter of proximal element 12A is sized to match that of the manufacturer's existing axle spindle 26 shown in FIG. 1C. To accomplish this, embodiment 11C is manufactured with holes 15A that line up with holes 15 in OEM spindle brackets 23 shown in FIG. 1A to accept stabilizing fasteners 21 illustrated in FIGS. 1A and 1B.

FIG. 7A shows an alternative embodiment 11D to embodiment 11C from FIG. 7, designed to provide two possible spindle sizes on the same embodiment of spindle size adapter 11D. The proximal element 13B of spindle size adapter 11D is extended to a length equal length of distal element 13 of spindle size adapter 11D forming interconnecting element 14A. Element 13B is manufactured to a provide a different diameter than element 13 whereby when the relative positions of element 13 and element 13B are reversed, the spindle size adapter will mate closely with a different size of wheel hub 28 shown in FIG. 3. Proximal element 13B may or may not be the same diameter as interconnecting element 14A.

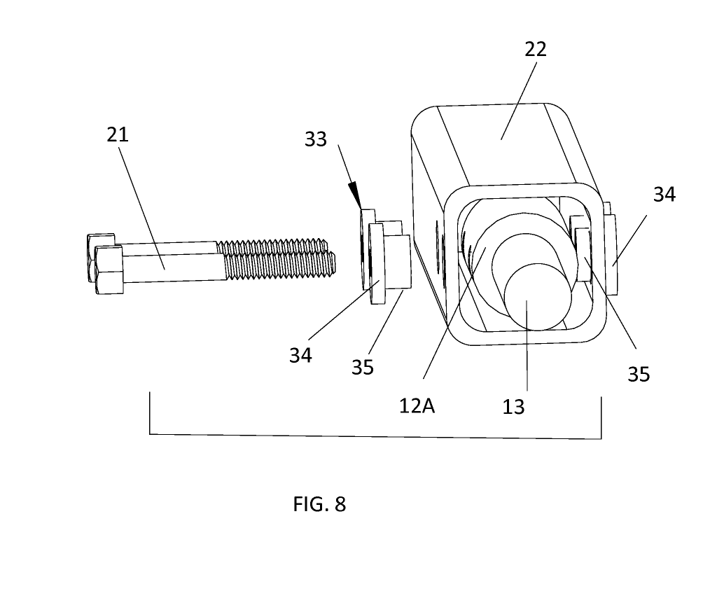

FIG. 8 shows a stabilizer bushing 33 designed to stabilize adapter 11C from FIG. 7 when adapter 11C is used with square axle frame 22. Stabilizer bushing 33 is comprised of machined or cast aluminum or other metals, molded, machined or extruded plastics, or molded or machined laminated fibrous materials. Stabilizer bushing 33 is comprised of a widened cap 34 that functions as a washer with an extended ferrule 35 that extends into axle frame 22 and comes into contact with spindle adapter 11C thereby preventing the fore and aft movement along the longitudinal axis of the dolly by the spindle adapter 11C. Fasteners 21 prevent vertical and horizontal movement of spindle adapter 11C.

### CONCLUSION, RAMIFICATIONS, AND SCOPE

Thus the reader can see that various embodiments of the spindle size adapter for dolly axles provides a useful, easily installed, and economical method of varying the dolly spindle size so that the user can use aftermarket wheels and tires that have different hub sizes. These replacement wheels are relatively inexpensive compared with original equipment manufacturer (OEM) supplied wheels and are available in a wide variety of styles to meet different user needs, including use on different terrains. Furthermore, the spindle adapter has the additional advantages in that:
The ease of removal and installation of wheels on this adapter and the ability to use a range of spindle sizes with the same adapter provides the user with an option of substituting a variety of wheels when he portages his dolly under different conditions and on different terrains.
The adapter provides its own stabilization to the axle frame and thus can be used without the OEM existing spindle bracket to provide the stabilization. The ability to function without the OEM spindle bracket enhances its flexibility and adaptability to a wide range of dolly axles.
The adapter is easily modified to function with axle frames of different styles by modifying the proximal end of the spindle adapter, adding a interconnecting element between the proximal and distal end of the spindle adapter, and/or providing adapter stabilizer bushing.
Spindle sleeves may be color coded to provide easy recognition of sizes which would be useful for sailing clubs for refitting wheels.

While my above description contains many specificities, these should not be construed as limitations on the scope, but rather as an exemplification of several embodiments thereof. Many other variations are possible. For example, a spindle adapter can be constructed so that the proximal element, either square or round in cross section, possesses an axial lumen that encompasses a tube forming a spindle whose distal end is the desired spindle size and which is held in the lumen by means of a fastener.

Accordingly, the scope should be determined not by the embodiments illustrated, but by the appended claims and their legal equivalents.

We claim:

1. A spindle size adapter for axle spindles comprising
a. a proximal element providing means for mating closely with an axle frame thereby stabilizing said proximal element and preventing vertical, fore and aft, and horizontal motion and
b. a distal element comprising a spindle providing means for mounting a wheel hub on said distal element and
c. said spindle possessing an outside diameter designed to fit a wheel hub of a different diameter
d. whereby a user has the options of mounting a variety of wheels with different styles and hub sizes that are better adapted to different terrains, ramps or conditions.

2. The spindle size adapter for axle spindles of claim 1 wherein an interconnecting element is located between the proximal element and the distal element
a. said interconnecting element of claim 2 providing structural elements to mate with portions of existing manufacturer's axle, spindle brackets or a plurality of fasteners and holes
b. whereby user can use the axle spindle size adapter of claim 1 with existing manufacturer's axle, spindle brackets or a plurality of fasteners and holes.

3. An spindle size adapter for axle spindles of claim 1 wherein the spindle includes a removable sleeve and
a. said sleeve providing the means of mating concentrically with the said spindle of claim 1 and
b. said sleeves possessing different outside diameters providing means to vary the effective outside diameter of said distal element
c. whereby said spindle fit into a variety of hub sizes.

4. The spindle size adapter for axle spindles of claim 1 wherein said proximal element possessing an axial lumen and said distal element comprising a spindle and a proximal extension
a. said axial lumen providing means for said proximal element to mate with a distal element
b. said proximal extension of distal element is shaped to mate with said lumen in said proximal element and
c. different said spindles possessing different outside diameters to provide a variety of different axle sizes and
d. said different outside diameters fit into wheel hubs of different sizes and styles and
e. whereby a user can utilize wheels of different hub sizes on a given dolly.

5. The spindle size adapter for axle spindles of claim 1 wherein the exterior surface of said proximal element is rounded into a tubular shape
a. said proximal element providing means for said spindle size adapter to mate with the inner lumen of round axle frames or
b. said proximal element providing means for said spindle size adapter to mate with a existing manufacture's spindle bracket and
c. said proximal element optionally extended to provide a different spindle size adapter when reversed with said distal end of said spindle size adapter and
d. different said spindle adapters providing a means to provide a variety of different spindle sizes and
e. said different outside spindle sizes fit into wheel hubs of different sizes and styles and
f. whereby a user can utilize wheels of different hub sizes on a given dolly.

6. A stabilizer bushing for said spindle size adapter of claim 5 comprising
a. a widened cap that functions as a washer and
b. an attached ferrule extending into interior of an axle frame and contacting the lateral surface of said spindle size adapter and
c. said ferrules prevent the fore and aft movement of said spindle size adapter
d. whereby said spindle size adapter can be used with square axle frames or axle frames with lumens unable to mate with said spindle size adapter
e. thereby increasing the versatility of said spindle size adapter design.
